(19) United States
(12) Patent Application Publication
(10) Pub. No.: US 2025/0302067 A1
(43) Pub. Date: Oct. 2, 2025

(54) APPARATUS FOR PROCESSING PLANT-BASED PROTEINACEOUS FOOD ITEMS, SET OF FOOD ITEMS AND METHOD OF PROCESSING

(71) Applicant: PLANTED FOODS AG, Kempttahl (CH)

(72) Inventors: Lukas Böni, Zurich (CH); Eric Stirnemann, Kemptthal (CH); Judith Wemmer, Zurich (CH)

(21) Appl. No.: 18/863,061

(22) PCT Filed: May 5, 2023
(86) PCT No.: PCT/EP2023/062022

§ 371 Date: Nov. 5, 2024

(30) Foreign Application Priority Data
May 6, 2022 (EP) 22172120.2

(51) Int. Cl. A23J 3/26; A23J 3/14

(52) U.S. Cl. CPC A23J 3/26; A23J 3/14

(57) ABSTRACT

The present invention relates to an apparatus for processing plant-based proteinaceous food items, including at least one extruding device configured to provide at least one plant-based proteinaceous extrudate, at least one separating device configured to separate the extrudate into a plurality of food pieces and at least one sorting station configured for sorting the food pieces based on one or more criteria.

The present invention further relates to a set of food items produced from at least one plant-based proteinaceous extrudate and a method of processing plant-based proteinaceous food items.

### CROSS-REFERENCE TO RELATED APPLICATIONS

The present application is a § 371 national phase entry of and claims priority of International patent application Serial No. PCT/EP2023/062022, filed May 5, 2023, and published in English, and further claims priority to European patent application no. 22172120.2, filed May 6, 2022.

### FIELD

The present disclosure relates to an apparatus for processing plant-based proteinaceous food items, including at least one extruding device, at least one separating device, and at least one sorting station, optionally equipped with at least one control unit configured to adjust, control and/or regulate one or more, optionally quality-related, parameters of the food items.

### BACKGROUND

Current meat consumption is depleting natural resources while fueling climate change. The current world-wide meat consumption is unsustainable and therefore meat alternatives must be developed to counteract the ever-growing consumption of meat and at least partially replace the consumption of conventional meat.

Various approaches have been applied for the production of meat alternative products resulting in relatively large differences in texture and/or nutritional value. For instance, tofu and some more modern products, such as plant-based sausages and/or meat loafs, are produced by gelation of watery dispersions/solutions of proteins and/or polysaccharides. This approach generally results in products which have relatively low protein contents, e.g., less than meat, and/or soft, silky, springy, and relatively juicy textures which lack a degree of fibrosity which is comparable to whole cuts or pieces of animal meat, such as from muscle tissue, respectively.

Meat alternatives which have a fibrous structure, such as plant-based chicken pieces, have also been proposed, e.g., by high moisture extrusion cooking (HMEC) or shear cell (SC) processing, in which proteins are molten under relatively high temperature, relatively high pressure and at moisture contents of 40-80% and subsequently cooled under shear resulting in the formation of a solidified fibrous structure.

Although various production processes for producing proteinaceous fibrous structures have been established, such as those described above, post-processing such structures with fibrous appearance, shape and/or texture similar to existing processed animal-based products is more challenging due to their relatively high tensile strength, stiffness and smooth surface. In addition, simple cutting of such proteinaceous fibrous structures, such as an extrudate, into strips, cubes and/or other geometrical shapes, is often performed by producers using machines designed for cutting animal meat or for cutting foods, such as vegetables into cubes. However, the machines designed for cutting animal meat or other food products generally apply simple and smooth cutting which does not allow to sufficiently preserve and/or provide a fibrous structure of the resulting food items. Instead, meat-like products with surfaces resulting from smooth cuts do not sufficiently resemble conventional meat, as it fails to present sufficient fibrosity and are thus perceived as being “unnatural”, “synthetic” and/or “processed” by the consumer. This perception is further supported by the generally smooth surfaces and angular shapes of texturized protein products, owning to the well-defined geometrical shapes in the formative steps of the texturization processes.

Methods for separating extrudate into pieces have been developed to provide food pieces with a fibrous appearance which highlights the fibrous structure, for instance WO 2021/181291 A1 which is herewith incorporated by reference in its entirety.

Furthermore, a “local” inner structure may vary over a flow profile, i.e., an orientation of an inner fiber structure, meaning that depending on where the separating device impacts the extrudate, the extrudate may separate non-uniformly.

WO 2022/012879 A1 discloses controlling extrudate properties by adapting process parameters of the extruding device to control the fibrosity of the extrudate. However, the fibrosity of the extrudate is dependent on raw material fluctuations, unpredictable process instabilities and/or predictable process changes over time to a relatively large extent, which renders such a method of adapting process parameters of the extruding device unreliable and/or imprecise for controlling properties of the extrudate.

Thus, embodiments of the present invention provide an improved means for reducing, mitigating and/or managing inconsistencies in the properties of produced fibrous food pieces.

### SUMMARY

In a first aspect of the disclosure, food pieces may be produced and subsequently graded and/or classified and/or sorted, e.g., to ensure an output quality of the food items, by an apparatus combining an extruding device with a separating device and a sorting station, that allows, e.g., undesired food pieces to be removed. This may prevent, manage and/or mitigate the effect of uncontrollable process fluctuations and/or may split the stream of food pieces provided by a separating device into several qualities and/or classes and/or grades of food pieces. In a second aspect of the disclosure, the apparatus is equipped with sensors and/or actuators to sense and/or predict one or more fluctuations, and optionally change one or more process parameters to adjust, regulate and/or control the extrudate quality and/or the food piece quality.

The current disclosure proposes an apparatus for processing plant-based proteinaceous food items, including:
(i) at least one extruding device configured to provide at least one plant-based proteinaceous extrudate;
(ii) at least one separating device configured to separate the extrudate into a plurality of food pieces; and
(iii) at least one sorting station configured for sorting the food pieces based on one or more criteria.

Thus, for instance, the apparatus may be configured to process protein-containing extrudate to provide one or more product streams for different food piece qualities, such as different sizes and/or different shapes and/or different colors.

The apparatus, more specifically the separating device, may be configured to provide “non-identical” or “non-repetitive” food pieces, wherein the terms “non-identical” or “non-repetitive” may refer to food pieces which differ in macroscopic shape from each other with a relatively low probability of producing identical food pieces, e.g., less than 10 wt % of the total weight of the produced food pieces may be substantially identical.

The apparatus, more specifically the separating device, may be configured to provide a non-smooth separation or cut, wherein the term non-smooth separation or cut may refer to a separating method of separating an extrudate into a plurality of pieces such that non-smooth surfaces are effected at the separation interface of each food piece. The resulting macroscopic shape may be a function of the mechanical impact and the inner structure or mechanical properties at the location of impact. The mechanical impact may be a combination of shear forces and elongational forces.

In other words, a non-smooth separation or cut provided by the separating device may result in one or more irregular and/or non-smooth cut faces and/or cut surfaces of the food pieces. For instance, the cut face(s) and/or cut surface(s) of the food pieces may be jagged, serrated, non-planar, wavy, stepped, fibrous in appearance and/or relatively rough. Alternatively, or additionally, one or more fibers, which are present in the food pieces, may extend to positions which do not lie in a single plane at the cut faces and/or cut surfaces of the food pieces. For instance, one or more fibers may extend beyond and/or project from the cut faces and/or cut surfaces of the food pieces and/or one or more further fibers may terminate prior to the cut faces and/or cut surfaces of the food pieces, e.g., within the food pieces.

The term “sort”, as referred to herein, may be interpreted as including any type of determination that the respective food pieces belong to one or more groups, classes, categories, grades, types, product streams and/or any other kind of allocation of the food pieces. The term “sort” may also include physically moving the food pieces, e.g., based on the one or more groups, classes, categories, grades, types, product streams and/or any other kind of allocation or assignment of the food pieces, to which the respective food pieces have been allocated and/or assigned.

The food pieces may be allocated or assigned based on similarity, i.e., sharing or having one or more similar properties, and/or the food pieces may be allocated or assigned based on dissimilarity, i.e., based on the food pieces having one or more properties which vary/differ between food pieces.

The sorting station may ensure the food pieces match and/or are within tolerances of one or more specifications, optionally predetermined specifications. The sorting station may distinguish and/or separate food pieces, which do not match and/or are not within tolerances of said specification, from food pieces, which match and/or are within tolerances of said specification.

This may serve as a quality control and/or a means for grouping and/or allocating food pieces according to the one or more criteria. For instance, the sorting station may allow food pieces, which are considered to be unacceptable, e.g., outside allowable tolerances, according to one or more criteria, to be discarded or re-fed to an upstream station of the apparatus, e.g., to the separating device and/or the extruding device, for reprocessing. This may enable a greater control over the quality of food pieces, e.g., food pieces which meet one or more predetermined requirements and/or criteria, to be achieved. This may also allow inconsistencies in the properties of fibrous food pieces, which are produced by the apparatus, to be reduced, mitigated and/or managed. This may allow waste, e.g., rejected and/or unsellable and/or unusable food pieces, to be reduced.

Moreover, the sorting station may allow certain types of food pieces, e.g., food pieces which are within a certain size range and/or have a certain shape, and/or certain combinations of food pieces, e.g., a certain variety of food pieces, e.g., food pieces having different sizes, to be classed and/or grouped and/or sorted together, e.g., for subsequent packaging. For instance, similar to animal meat processing, in which different cuts of meat end up in different product streams or pieces serving different end applications, the apparatus described herein may classify and/or grade and/or group food pieces, e.g., at the sorting station, to provide different streams of food pieces and/or to group different food pieces serving different end applications.

As described at the beginning, WO 2021/181291 A1 proposes separating extrudate to provide food pieces which highlight their fibrous structure. Performing a “non-smooth” cut results in non-identical food pieces and/or non-repetitive food pieces and a partly stochastic output, as the macroscopic shape is a function of the mechanical impact on the extrudate and inner structure of the extrudate at the location of mechanical impact.

However, the inventors have found that, when applying high-moisture extrusion to produce the fibrous material, referred to as an extrudate, the inner fibrous structure results from the formation of a flow profile in the cooling die and is thus highly dependent on raw material quality, process parameters and/or process conditions. As high-moisture extrusion can be a rather unstable process, based in particular on complex fluid mechanics and time-dependent molecular interactions, slight changes and/or fluctuations in one or more properties of the raw material and/or the process may result in a change in fibrous structure, which in turn may affect the performance in a separating device. This may result in inconsistencies in the properties of the produced fibrous food pieces. Thus, the properties of the produced fibrous food pieces may vary from food piece to food piece. WO 2022/012879 A1, which is also mentioned at the beginning, proposes adjusting parameters of the extruding device to control the fibrosity of the extrudate. However, the inventors have found that adapting process parameters of the extruding device is unreliable and/or imprecise for controlling properties of the extrudate.

Thus, the present disclosure improves on reducing, mitigating and/or managing inconsistencies in the properties of produced fibrous food pieces by sorting the food pieces at the sorting station. This may enable the food pieces to be sorted, e.g., based on one or more physical properties of the food pieces, e.g., to allocate the food pieces to one or more classes and/or to correct food pieces which are deemed inadequate or undesirable at the sorting station, e.g., by re-feeding the respective food pieces for re-processing, e.g., by the extruding device and/or the separating device. This may ensure that food pieces which meet one or more, optionally predetermined, standards are output for consumption. This may be a more reliable and controllable means for reducing, mitigating and/or managing inconsistencies in the properties of produced fibrous food pieces than adapting process parameters of the extruding device, as disclosed in WO 2022/012879 A1, in particular due to the various instabilities and/or fluctuations associated therewith. This may also enable the quality of the final product, i.e., the food items, to be controlled and/or verified directly, which may result in a more effective control over quality.

The sorting station may be configured for manual sorting, e.g., which is performed manually by one or more humans. Alternatively, the sorting station may be configured for automatic sorting, e.g., by including one or more sorting devices configured to automatically, or semi-automatically, sort the food pieces. Further alternatively, the sorting station may be configured for manual and automatic sorting, e.g., the sorting station may be based on manual sorting which is assisted by one or more devices, optionally automated devices, e.g., one or more robots. The one or more devices may be configured to check the quality of work performed by one or more humans who are manually sorting the food pieces.

The one or more criteria, on which the sorting is based, may be compared with the food pieces, e.g., in order to determine how the respective food pieces are to be sorted, e.g., accepted or rejected/re-fed. The comparison may be performed manually, e.g., by humans, and/or in a machined fashion, e.g., by one or more automated devices, e.g., robots. The one or more criteria may be fixed and/or may be adapted, e.g., based on the sorting results and/or customer satisfaction. For instance, the one or more criteria may be adapted based on artificial intelligence and/or machine learning.

The sorting station may be configured for classifying/assigning the food pieces into one or more different classes and/or types of food pieces and/or to physically group and/or separate at least one first type of food pieces from at least one second type of food pieces. As discussed above, the sorting station may be configured for manual sorting, automatic sorting, or semi-automatic sorting of the food pieces. The sorting station may be configured to perform the sorting of food pieces based at least partially on artificial intelligence and/or machine learning.

The one or more criteria may be one or more physical properties of the food piece, optionally detectable physical properties of the food piece.

Physical properties of the food pieces may include size, shape, color, mechanical properties, fibrosity, density, water content, protein content, a morphology, a color pattern, or weight.

The term “size” refers to any parameter or value for quantifying one or more spatial dimensions of an object, e.g., of the food items and/or the food pieces, such as a length, a width, a height, a perimeter, a radius of gyration, or a projected area.

The term “height” may refer to a dimension which extends perpendicularly to a surface, e.g., a surface of a conveyor belt on which the extrudate or food piece is arranged. The height may correspond to a height of a channel of a cooling die, which may be configured to pre-separate, e.g., slice, the extrudate into smaller portions, e.g., strips or layers, prior to separating the extrudate into food pieces by the one or more separating devices. The terms “width” and “length” may refer to the other two dimensions of an object, e.g., of the food items and/or the food pieces, not being the height, wherein the length is the longer dimension and the width being the shorter dimension of the other two dimensions.

“Shape” can be described by an anisotropy factor being a function of the aspect ratio (length over width), by polygon shape indices, by fractal dimensions or by combining several sizes such as perimeter over area.

Color can be described by an RGB value or by a HEX value or by a greyscale value.

Color pattern may include dots or stripes on the surface, imperfections, or colour gradients, which may result from an actual color difference or spectrum on the food piece or from a surface structure resulting in a color pattern on an image taken of the food piece.

Optionally, the sorting station of the apparatus may include at least one sorting device which is configured to classify the food pieces into one or more classes of a plurality of classes based at least on the one or more criteria. The one or more criteria may be defined and trained via classification using neural networks.

The sorting device may be configured to grade the food pieces. Optionally, the sorting device is configured to individually classify each food piece into a corresponding class. Each class may represent a certain shape, size, and/or weight of the food pieces to be classified therein. Optionally, each food piece is classified according to one or more criteria, whereas said criteria may be one or more physical properties of the food piece, optionally said criteria are detectable physical properties of the food piece.

The one or more criteria may be the physical properties directly or further processed into ratios, time-based averages, weight-based averages, number-based averages, or factors of physical properties or by feeding the physical properties into a model or algorithm or deep-learning algorithm or optimization functions.

In one embodiment, several criteria are combined and fed into an algorithm to optimize a quality-output function.

In one embodiment, the defined one or more criteria lead to a hard cut-off. In an alternative embodiment, the criteria may be defined as soft boundaries to optimize the output of food items while staying as close to the criteria as possible.

The “proteinaceous” extrudate/food pieces may contain one or more types of protein or be made entirely of one or more types of protein. In particular, said proteinaceous extrudate/food pieces may comprise at least 10 wt % protein, optionally at least 15 wt % protein, optionally at least 20 wt % protein, optionally include one or more of the following group: pea, soy, wheat, sunflower, fava, pumpkin, rice, cereals, pulses, oil seeds, algae, single cells, fungi, and fermented components such as cultivated animal cells or a mixture thereof.

“Protein” refers to protein isolate, concentrate or flour or combinations thereof, which may also contain other macronutrients, such as carbohydrates, fats, dietary fibers, salts, or residual water. Said isolate, concentrate, flour or combination thereof optionally contains a pure protein content of at least 40 wt %, optionally at least 50 wt %, more optionally at least 60 wt %. The protein isolate, concentrate or flour (“protein”) could also be referred to as a “protein composition” or “protein powder” in the context of the present disclosure.

Optionally, the proteinaceous extrudate/food pieces include, in at least sections thereof, a fibrous structure. The term “fibrous structure” refers to a structure which includes fiber bundles and/or fiber aggregates and/or aggregated fibers and/or fiber sheets, sometimes more generally referred to as “fibers”, in particular made of protein(s), resulting in anisotropy characteristics regarding structure and mechanical properties of the fibrous structure. Optionally, the fibrous structure has a relatively high degree of alignment of fibers in one direction and/or are aligned in the pattern of a flow profile. The fibrous structure is formed in the wet texturization process as proteins and other components are stretched and/or aligned by application of shear. The fibrous structure resulting from wet texturization is known to a person skilled in the art and results in a chewy, animal-meat-like texture and/or appearance.

The extruding device may include at least one extruder, for example a single screw, double screw or planetary extruder, optionally a conditioner or pre-conditioner, and a die, optionally a cooling die, and any other parts such as transition parts between the extruder and the cooling die.

The extruding device optionally produces at least one strand or ribbon or slab, optionally two strands or ribbons or slabs, of extrudate, optionally one or more continuous strands or ribbons or slabs of extrudate. The extruded strands or ribbons or slabs may be cut or separated into several smaller strands or ribbons or slabs, optionally being larger than 5 cm×10 cm in the two greatest dimensions. Both the complete, or non-separated, and pre-separated strands or ribbons or slabs are referred to herein as extrudate.

The strand or ribbon or slab of extrudate exiting the extruder optionally has approximately the height of the channel of the cooling die or optionally slightly thinner, e.g., between 0% to 20% thinner, in case of shrinkage upon exiting. Alternatively, the extrudate may be lightly thicker than the channel of the cooling die, optionally 0% to 30% thicker in case of expansion after exiting the cooling die, for example caused by formation of pores or bubbles.

The strand or ribbon or slab of extrudate exiting the extruder optionally may have approximately the width of the cooling die channel or may be 0% to 20% more narrow in case of shrinkage upon cooling. Alternatively, the extrudate may be cut at the exit of the cooling die into 2, 3 or more than 3 separate strands, ribbons or slabs. Optionally the width of the cooling die channel, which is referred to as the perimeter in case of an annular cooling die, is larger than 5 cm, optionally between 5 cm and 150 cm, optionally between 6 cm and 120 cm.

The separating device can be configured to rip, cut, tear, break, roll, squeeze, punch, elastic-plastically deform or apply any other mechanism for physically separating one section of the extrudate from another section of the extrudate to provide the food pieces. Optionally the separating device provides non-identical food pieces.

The separating device may include one or more devices, optionally arranged in series. Optionally, the separating device is at least configured to elastic-plastically deform the extrudate, optionally the separating device is at least configured to elastic-plastically deform the extrudate by means of rolling.

Optionally, the separating device is configured to perform a separation resulting in an irregular shape of the food pieces, i.e., resulting in a non-uniform or irregular separation of each food piece, e.g., to provide irregular shapes and/or surfaces of the food pieces. Optionally, the separating device does not act purely on shear forces but involves a combination of shear and elongational forces, or pre-dominantly elongational forces.

The separating device may produce food pieces which include a fraction of food pieces which are determined or classified as being “too small”. Optionally, food pieces which are smaller than a target size of food pieces by at least 10%, optionally at least 5%, optionally at least 2%, may be determined or classified at the sorting station as being “too small”. Optionally, food pieces which are smaller than the target size of food pieces, e.g., food pieces of one or more particular classes, are determined or classified at the sorting station as being “too small”.

The separating device may produce food pieces which include a fraction of food pieces which are determined or classified at the sorting station as being “too large”. Optionally, food pieces which are at least 50%, optionally at least 80%, optionally at least 100%, larger than a target size may be determined or classified as being “too large”.

Food pieces which are larger than the target size of a class may be determined or classified as being “too large”.

The target size may be one specific size and/or a range of sizes, optionally a combination of several sizes combined in an “AND” or “AND-OR” function.

The food pieces not re-fed but allocated to one or several different classes of food pieces may be no greater in length than 10 cm, optionally no greater in length than 8 cm, optionally no greater in length than 7 cm. In other words, food pieces having a length greater than 10 cm, optionally greater than 8 cm, optionally greater than 7 cm may be sorted out and/or re-fed.

Alternatively or additionally, the food pieces not re-fed but allocated to one or several different classes may be at least 0.5 cm in length and/or width, optionally at least 1 cm in length and/or width, optionally at least 1.5 cm in length and/or width, optionally at least 2 cm in length and/or width. In other words, food pieces having a length and/or width smaller than 0.5 cm, optionally smaller than 1 cm, optionally smaller than 1.5 cm, optionally smaller than 2 cm may be sorted out and/or re-fed.

Alternatively, or additionally, the food pieces not re-fed may be no greater than 10 cm in width, optionally no greater than 7 cm in width, optionally no greater than 5 cm in width, optionally no greater than 4 cm in width.

Alternatively, or additionally, the food pieces sorted out for allocation to one or several food items may have an area or a projected area of no more than 1500 mm2, optionally no more than 1200 mm2.

Alternatively, or additionally, the food pieces may be sorted into three groups, wherein:
group 1 comprises food pieces with a length and width between 2 cm and 5 cm,
group 2 comprises food pieces with a length of between 2 cm and 7 cm and a width between 2 cm and 5 cm that are not comprised in group 1, and
group 3 comprises all pieces not comprised in group 1 or group 2.

The food pieces may be sorted mechanically prior to a further sorting step, wherein the mechanical sorting may be performed with a sieve with a diameter of greater than 5 mm, optionally greater than 10 mm, optionally greater than 12 mm and less than 20 mm. Optionally, said food pieces sorted out by the sieve are re-fed.

The food pieces may be sorted into three classes, wherein:
a first class may be sorted out mechanically by passing over a sieve with a diameter greater than 10 mm but less than 20 mm, the remaining food pieces are sorted optically,
a second class may include food pieces with a length greater than 7 cm and an area greater than 1000 mm2, optionally greater than 1200 mm2, and
a third class may comprise all remaining pieces.

Optionally, the third class may further be sorted into a fourth class with food pieces with an area between 500 mm2 and 1000 mm2.

In one embodiment, a class of food pieces may be sorted out with an aspect ratio between 1 and 2.5, optionally between 1 and 2 and an area between 500 mm2 and 1200 mm2, which is used as one food item, wherein all other pieces are optionally further sorted and used for other food items or are re-fed.

In an alternative embodiment, food pieces having a length no greater than 12 cm, optionally no greater than 10 cm, and a width no greater than 3 cm, optionally no greater than 2 cm are sorted into one class.

In an alternative embodiment, food pieces with a radius of gyration no greater than 6 cm, optionally no greater than 5 cm, optionally the radius of gyration is no greater than 5 cm and at least 1.5 cm, optionally the radius of gyration is between 1.5 cm and 5 cm and an aspect ratio of at least 2, optionally at least 3, are sorted into one class.

In an alternative embodiment, the food pieces may be sorted into a group of pieces with a length of no more than 7 cm and at least 1.5 cm, optionally at least 2 cm, and into another group of smaller pieces and into a third group of larger pieces.

In one embodiment, the food pieces are sorted into a group of pieces with a length of not more than 7 cm and at least 1.5 cm and an aspect ratio between 1 and 2.

Optionally, the sorting station of the apparatus includes a sorting device which is configured to classify the food pieces into one or more classes of a plurality of classes based on the one or more criteria, wherein the sorting device is configured to allocate the food pieces based on the one or more criteria such that food pieces which are classified into a first class by the sorting device are fed to at least a first processing station and food pieces which are classified into a second class by the sorting device, which is different from the first class, are fed to at least a second processing station which is different from the first processing station.

Optionally, the food items/food pieces are fed in a plurality of different streams. For instance, different sizes and/or different shapes are allocated/assigned to different streams.

Food pieces having varying sizes and/or shapes and/or aspect rations, etc., may result from the separation process performed by the separating device.

The first processing station and/or second processing station may correspond to the next processing station or any processing station arranged “downstream”, i.e., any downstream processing station for processing the food pieces. The first processing station and/or second processing station may also be an upstream processing station, to which at least some food pieces are re-fed, e.g., to the extruding device and/or the separating device, if the respective food pieces are classified to be “re-fed”. This may be the case if the respective food pieces are determined, at the sorting station, as being “too small”, in which case the respective food pieces may be re-fed to the extruding device for re-extrusion, or as being “too large”, in which case the respective food pieces may be re-fed to the separating device to separate the respective food pieces into smaller pieces.

The different classes may group food pieces according to a specific functionality and/or a specific purpose and/or a specific application. The different classes may group food pieces according to whether they are edge pieces or not. The different classes may group food pieces according to whether at least one outer surface of the respective food piece corresponds to an outer surface of the extrudate. The different classes may group and/or class food pieces according to whether at least a predetermined length of an outer surface of the respective food piece corresponds to an outer surface of the extrudate. The different classes may group food pieces according to whether at least a predetermined ratio of the outer surface of the respective food piece corresponds to an outer surface of the extrudate.

The sorting device of the apparatus may be configured such that a size of the largest food piece of the first class is no more than 20%, optionally no more than 15%, optionally no more than 10%, optionally no more than 1%, larger than a size of the smallest food piece of the second class. Hence, the sorting device of the apparatus may be configured to create a certain overlap of sizes. Moreover, the sorting device may be configured to sort food pieces which are relatively similar in size based on the one or more criteria, e.g., based on a size of the food pieces. In other words, the sorting device may be configured to distinguish one or more properties of one food piece from another food piece, the food pieces being relatively similar in size, e.g., having a difference in size, e.g., volume, projected area, aspect ratio and/or length, of no more than 5%.

The sorting device of the apparatus is configured such a size of the smallest food piece of one class is at most 95%, optionally at most 96%, optionally at most 97%, optionally at most 98%, optionally at most 99%, of a size of the largest food piece of the same class. Thus, the sorting device may be configured to sort food pieces, which have different sizes, e.g., based on relatively small size differences, into a single class. This may provide a class with a variety of sizes, e.g., to package food pieces having varying, but close, sizes in a single packaging. This may provide a more natural and meat-like appearance to the food items.

Optionally, the size of the smallest food piece of one class is at least 60%, optionally at least 65%, optionally at least 70%, optionally at least 75%, optionally at least 80%, optionally at least 85%, optionally at most 90%, of the size of the largest food piece of the same class.

Optionally, the one or more criteria, based on which the food pieces are sorted, relate to one or more physical properties of the food pieces, optionally one or more physical properties which are detectable by at least one detecting device which is optionally provided by the apparatus. For the purpose of detecting one or more physical properties of the food pieces, the apparatus may include one or more sensing devices, e.g., optical sensing devices, configured to sense the one or more physical properties of the food pieces. One or more optical sensing devices may be one or more near infra-red sensors and/or one or more hyperspectral sensors. The apparatus may include an optical camera.

The one or more criteria may relate to one or more of the following: a projected area of the food pieces, an aspect ratio of the food pieces, a shape of the food pieces, a size of the food pieces, a length of the food pieces, a perimeter of the food pieces, a colour of the food pieces, a surface pattern of the food pieces, a protein content of the food pieces, a water content of the food pieces, a density of the food pieces, a contour of the food pieces, a circumference of the food pieces and/or a weight of the food pieces.

For instance, the sorting station/device may sort a first set of food pieces which match, exceed or are less than a certain value, optionally predetermine value, and/or a range of values, optionally a predetermine range of values, of the above-identified properties/parameters from a second set of food pieces.

The sorting station may be configured to sort the food pieces based on information provided to and/or from one or more neural networks. The one or more neural networks may be included in the apparatus described herein and/or may be provided externally, e.g., remotely from the apparatus, wherein the one or more neural networks may be communicatively connected to the apparatus. Optionally, the one or more criteria are defined and/or altered and/or applied by the one or more neural networks. Optionally, the one or more criteria are defined and/or altered and/or applied by the one or more neural networks in a manner which resembles a learning and/or training human. This may enable a more precise sorting of the food pieces.

The sorting station of the apparatus may include at least one sorting device configured to at least partially automatically and/or digitally sort the food pieces based on the one or more criteria.

The sorting station of the apparatus may include at least one sorting device which includes at least one detecting device configured to detect one or more physical properties of the food pieces, optionally at least one of a size, a shape, and a color of the food pieces. The one or more physical properties may be compared with the one or more criteria in order to determine how to sort, e.g., into which class, group, grade, etc., the respective food pieces whose one or more physical properties were detected.

The detecting device of the apparatus may include one or more of the following: an optical detecting device, a tactile detecting device and an ultrasonic detecting device.

The extrudate may be one or more of the following: a high-moisture extrudate comprising at least 35 wt % water, and a fibrous structure.

Optionally, the extrudate is produced by high moisture extrusion cooking in an extruder, optionally in a twin-screw extruder:
at a moisture content of at least 35 wt %, optionally above 40 wt % and below 80 wt %, optionally between 45 wt % and 70 wt %,
and/or
at a protein content of above 10 wt %, optionally above 15 wt %, optionally above 20 wt %.

In particular, the mixture of protein, water and other components may be sheared and heated in the extruder to a temperature above 100° C., optionally above 120° C. and subsequently cooled in a cooling die to a temperature less than 120° C., optionally less than 100° C. before being ejected to avoid substantial puffing and to form a fibrous structure.

In one embodiment, the extrudate may comprise pea protein as the only protein source. In an alternative embodiment, the extrudate may comprise pea protein as well as at least one other protein source, optionally a plant-based protein source. In an alternative embodiment, the extrudate may comprise at least pea protein, sunflower protein and oat protein. In an alternative embodiment, the extrudate may comprise at least pea protein and yeast protein. In an alternative embodiment, the extrudate may comprise at least pea protein and soy protein source.

In an alternative embodiment, the extrudate may comprise soy protein as the only protein. Besides water and proteins/protein compositions/protein powders, the extrudate may comprise any other edible component(s) which is/are added prior to and/or during the wet texturization process, such as oil or fat, dietary fibers, flavour components, colorants, or carbohydrates. The other components are optionally from non-slaughtered origin, optionally plant-based, fungi, fermentation processes, lab-grown animal cells, and/or single cell organisms.

The apparatus may further include at least one re-feed device configured to feed one or more of the food pieces to an upstream position relative to the extruding device and/or the separating device to re-feed the food pieces to the extruding device and/or the separating device. For the purpose of re-feeding one or more food pieces, the apparatus may be provided and/or communicatively connected with at least one control device, optionally providing a forward feed and/or backward feed control loop. The control device may be configured to determine and/or initiate re-feeding of one or more food pieces, e.g., based on the one or more criteria. The control device may further be configured to adjust/adapt one or more parameters, e.g., process parameters, as described further below, based on the re-feeding of one or more food pieces, e.g., based on a rate of re-feed. The upstream position is determined based on a direction in which the food pieces are fed to and/or introduced into the extruding device and/or the separating device. In particular, one or more food pieces may be classified/graded as requiring reprocessing by the extruding device and/or the separating device. This may be the case if the respective food pieces are determined, at the sorting station, as being “too small”, in which case the respective food pieces may be re-fed to the extruding device for re-extrusion, or as being “too large”, in which case the respective food pieces may be re-fed to the separating device to separate the respective food pieces into smaller pieces.

Optionally, when re-feeding into the extruding device, the food pieces are further reduced in size by crushing, milling, mushing, cutting or separating said food pieces in any other manner. Optionally, a size of the re-fed food pieces are adjusted prior to being introduced into the extruding device to be more uniform to allow gravimetric or volumetric feeding intro the extruding device. The food pieces may be processed in one or more processing steps prior to re-feeding into the extruding device, including mixing with other components, drying, wetting, cooling, and/or heating. Optionally, when re-feeding into the extruding device, one or more process parameters of the extruding device are adjusted and/or adapted to account for the additional in-flow of material by means of the re-fed food pieces.

Optionally, food pieces that are smaller than target food pieces desired for a specified product stream are re-fed into the extruding device. Food pieces that are larger than target food pieces desired for a specified product stream may be re-fed either into the extruding device or into a separating device. The apparatus described herein may include a plurality of separating devices. The food pieces may be re-fed into a first separating device of the plurality of separating devices or at any other position downstream of the first separating device, e.g., at a position downstream of the first separating device and upstream of a further separating device, the further separating device being arranged downstream of the first separating device.

The re-feed device may be composed of one or several devices. When re-feeding into the extruding device, said re-feed device is optionally configured to feed a specified weight or volume of a re-feed material, e.g., one or more re-fed food pieces. Optionally, said re-feed device, which is configured to re-feed food pieces to the extruding device, may be communicatively connected with a control unit of the extruding device.

The apparatus may be configured such that no more than 50%, optionally no more than 40%, optionally no more than 30%, of all processed food pieces are re-fed to the extruding device and/or the separating device. Limiting the percentage of re-fed food pieces may increase the efficiency and/or throughput of the apparatus. This may reduce the production time for a target number, weight or volume of food items.

The term “percentage of all processed food pieces” or “% of all processed food pieces” may refer to a percentage by weight (wt %) of all processed food pieces, a percentage of a total area of all processed food pieces, a percentage by volume (vol %) of all processed food pieces or a percentage of a number of all processed food pieces.

The apparatus may be configured such that one or more of the food pieces are re-fed to the extruding device and/or the separating device based on the one or more criteria. The apparatus may be configured to, based on the re-feeding of food pieces, e.g., based on a re-feed rate, adjust one or more parameters, e.g., one or more parameters of the extruding device and/or the separating device, e.g., by means of at least one control device. For instance, if the respective food pieces are determined, at the sorting station, as being “too small”, the respective food pieces may be re-fed to the extruding device for re-extrusion. If the respective food pieces are determined, at the sorting station, or as being “too large”, the respective food pieces may be re-fed to the separating device to separate the respective food pieces into smaller pieces or alternatively, the food pieces being determined as being “too large” may be re-fed to the extruding device.

The apparatus may be configured such that food pieces having a color which is determined as being too dark or too light, or an aspect ratio which is determined as being too high or too low, or a density which is determined as being too high or too low, or a water content which is determined as being too high or too low, or a protein content which is determined as being too high or too low, are separated and either re-fed into the extruding device and/or the separating device or separated as waste.

The apparatus may be configured to convert at least 80%, optionally at least 85%, optionally at least 90%, optionally at least 95%, optionally at least 96%, optionally at least 97%, optionally at least 98%, optionally at least 99%, of a raw plant-based proteinaceous material at an inlet of the extruding device to edible food pieces. This above-specified percentages may be referred to as a conversion rate of the raw plant-based proteinaceous material. Such values or value ranged may reduce waste and/or increase the efficiency and/or throughput of the apparatus.

The conversion rate may be achieved with or without re-feeding. Optionally at least 80%, optionally at least 85%, optionally at least 90%, optionally at least 95%, of the raw plant-based proteinaceous material may be packaged for consumption and/or for further processing at a co-manufacturer and/or customer.

The separating device may be configured to separate the extrudate into a plurality of food pieces in a manner such that the separated food pieces vary, optionally in at least one or more of the following physical properties: shape, weight, volume, texture, density, aspect ratio, perimeter, and one or more size dimensions, optionally at least in length. This may provide food items which have a variety of different physical properties, such as different sizes, e.g., to package food items, which have identical or similar properties, i.e., within a certain range, together in a single packaging and/or to package food items which have different properties, e.g., outside of a certain range, together in a single packaging. This may provide a more natural and meat-like appearance to the packaged food items.

Optionally, the apparatus, more specifically the sorting station, is configured such that no more than 10% of food pieces sorted into one class of food pieces are outside of a set of criteria for said class of food pieces, optionally no more than 5%.

The separating device may be composed of one or a plurality of separating devices.

Optionally, the separating device(s) may be configured to separate the extrudate into non-identical food pieces and/or non-repeating food pieces and/or arbitrary food pieces, e.g., with respect to the size and/or shape of the food pieces produced by the separating device(s). Optionally, the food pieces vary in size, aspect ratio and/or shape. Optionally, the food pieces vary in several physical properties, such as size, aspect ratio and/or shape.

The apparatus may further include at least one conditioning device configured to condition the extrudate and/or the food pieces to one or more target states of the extrudate and/or the food pieces. This may enable the extrudate and/or the food pieces to attain one or more target properties, such as a certain temperature, a certain temperature range and/or one or more structural features, such as a certain density and/or stiffness, e.g., prior to being further processed.

The conditioning device of the apparatus may be configured to condition the extrudate and/or the food pieces by controlling one or more of the following: at least one temperature, at least one colour and at least one structural property of the extrudate and/or the food pieces.

The conditioning device may be configured to actively cool and/or heat, e.g., by including one or more heating devices and/or cooling devices, and/or passively cooling and/or heating, e.g., by adjusting the time the extrudate is exposed to an environment, e.g., an ambient, to allow the extrudate to dissipate heat to said environment.

The conditioning device of the apparatus may include one or more sensors configured to detect one or more physical properties of the extrudate and/or the food pieces, optionally wherein the one or more sensors include one or more of the following: at least one temperature sensor, at least one tactile sensor, at least one ultrasonic sensor and at least one optical sensor.

The conditioning device may include at least one buffering device. The buffering device may be configured to condition the extrudate and/or one or more food pieces as one or more further food pieces bypass the conditioning device, e.g., since the one or more further food pieces do not require conditioning by the conditioning device or because the one or more further food pieces will be conditioned by the conditioning device at a different time and/or by a further conditioning device.

The conditioning device of the apparatus may be configured to provide, optionally in an adjustable manner, a duration until the extrudate and/or the food pieces are processed in a processing step which is downstream of the extruding device and/or the separating device, respectively. This may enable a degree of conditioning, e.g., a time of exposure to a certain, optionally tempered, environment to be adjusted and/or controlled to adjust and/or control one or more target properties which may be attained by the extrudate and/or food pieces(s) during the conditioning.

The conditioning device may comprise a conveying unit configured to convey the extrudate and/or the food pieces after passing one or more devices of the separating device. A speed of the conveying unit may be adjustable. In case the conditioning device includes at least one buffering device, the amount of material which can be buffered in the buffering device may be adjustable.

The sorting device of the apparatus may include at least one grouping unit configured to physically separate and/or group at least a first type of food pieces from at least a second type of food pieces based on the one or more criteria. The first type and the second type of food pieces may be different classes, categories, grades and/or any other kind of allocation or assignment of the food pieces based on the one or more criteria. Thus, the food pieces may be physically moved by the grouping unit based on the determined type of said food pieces, rather than merely associating the food pieces to a particular type or class. This may enable a more precise sorting and/or to more effectively and/or may efficiently generate a plurality of product streams of the food pieces.

The group(s) may be one or more rows/streams and/or clusters, e.g., provided on a conveyor belt.

The grouping unit of the apparatus may include at least one of the following:
at least one fluid emitting unit configured to eject a fluid to exert a force on one or more food pieces to physically separate and/or group the food pieces, and
at least one handling device configured to contact, in a tactile manner, one or more food pieces to physically separate and/or group the food pieces.

The grouping unit may comprise e.g., a picking device, e.g., a robotic arm with a grasping device provided at an end thereof. The fluid applied in the grouping unit can be at least one liquid and/or at least one gas, optionally air, e.g., emitted as at least one jet of gas/liquid.

The grouping unit of the apparatus may include at least one sieving device configured to separate smaller food pieces from larger food pieces. Optionally, the sieving device is configured as a vibrating sieve, optionally a continuously vibrating sieve.

The sieving device of the apparatus may be adaptable to food pieces of varying sizes, e.g., by adjusting size of hole(s) in sieve.

The apparatus may be configured to control, optionally automatically control, and/or regulate one or more process parameters of one or more devices provided by the apparatus. For the purpose of controlling, optionally automatically controlling, and/or regulating the one or more process parameters, the apparatus may include at least one control device including processing circuitry, and optionally a memory for storing data.

The process parameters may be operating parameters of one or more devices and/or values relating to a composition of the extrudate and/or food pieces.

The apparatus may be configured to control the one or more process parameters based on one or more measurands related to a device of the apparatus and/or the extrudate and/or the food pieces.

The measurands of the apparatus may include one or more physical properties of the food pieces and/or the food pieces, optionally wherein the one or more physical properties are detectable by at least one detecting device.

Optionally, data is fed to the extruding device and/or to the separating device via a control loop, optionally a forward feed and/or backward feed loop.

The process parameters may be operating parameters of the extruding device and/or the separating device and/or of a further device included in the apparatus.

The measurands of the apparatus may include one or more physical properties of the raw material of the extrudate fed into the extruding device, optionally wherein the one or more physical properties are detectable by at least one detecting device.

“Raw material” or “raw material of the extrudate” refers to any material fed into the extruder or the material inside of the extruder contributing to the composition of the extrudate. This may include powder, wet powder or liquid materials, including, but not limited to, protein powder and optionally also including food pieces that are re-fed to the extruding device. While “extrudate” refers to the material exiting the extruding device, “raw material” or “raw material of the extrudate” refers to any material, or ingredient, used to form the extrudate, wherein said “raw material” or “raw material of the extrudate” may be in a state prior to being introduced into the extruding device, in a state within the extruding device, i.e., as the extrudate is being formed, and/or in a state after being ejected from the extruding device, i.e., as a part of the produced extrudate. Thus, the “raw material” or “raw material of the extrudate” may be in the form of a powder, a liquid, an already extruded material, a dough, a melt, a single component or a multi-component mixture.

The measurands of the apparatus may include one or more of the following physical properties: at least one colour, at least one protein content, at least one water content, at least one solubility, at least one pH value and at least one particle size of one or more particles in the raw material.

The measurands of the apparatus may include one or more of the following parameters of the extruding device: at least one temperature imparted to the extrudate, at least one residence time of the extrudate in the extruding device, at least one pressure of the extrudate in the extruding device, at least one torque of the extruding device and at least one specific mechanical energy (SME) of the extruding device.

The measurands may further include one or more of the following parameters of the extrudate: at least one flow rate of the extrudate exiting the extruding device, at least one colour of the extrudate, at least one temperature of the extrudate, at least one density of the extrudate, at least one pH value of the extrudate, at least one hardness of the extrudate, at least one fibrosity of the extrudate, at least one size of the extrudate, at least one weight of the extrudate, at least one moisture content of the extrudate, at least one stiffness of the extrudate, at least one extensibility of the extrudate in at least one dimension and at least one cross-sectional shape of the extrudate.

The “flow rate of the extrudate” may refer to a weight or volume of the extrudate exiting the extruding device per time unit. Alternatively, the “flow rate of the extrudate” may refer to a velocity of the extrudate exiting the extruding device.

The apparatus may be configured to control one or more of the following:
a feeding rate of one or more ingredients of a raw material of the extrudate,
a throughput of the food pieces,
a rotational speed of the extruding device,
a temperature in at least a section of the extruding device,
a process parameter to control a residence time of the raw material in the extruding device,
a backpressure of the extruding device,
a process parameter of the separating device, optionally a separation speed or a feed rate of extrudate into the separating device,
a process parameter to control a residence time of the food pieces and/or the food items in at least one conditioning device,
a process parameter to control a temperature of the extrudate prior to entering the separating device,
a duration until the extrudate and/or the food pieces are processed in a processing step which is downstream of the extruding device and/or the separating device and/or at least one of a plurality of separating devices,
a conveying speed of the food pieces through at least a section of the apparatus,
a feeding rate of food pieces into and/or from a re-feed device, and
at least one of the one or more criteria based on which the sorting station is configured to sort the food pieces.

In particular, the rotational speed refers to the rotation of a screw of the extruding device. The composition of raw material includes powder, water, liquid or as steam, oil or other components, whereas each of these components may be fed separately or pre-mixed, at different locations of the extruding device, such as in the pre-conditioner, extruder, transition parts and/or at the cooling die. In particular, each component may be added or one or several separated streams or feeds. The temperature of the extruding device may be a barrel temperature and/or die temperature and/or pre-conditioner temperature and/or water temperature.

Adjustment to one or more of the above-identified parameters and/or conditions may be performed by one or more actuators resulting in a direct or indirect change of the respective parameter and/or condition.

In one embodiment, the feeding rate of food pieces by the re-feed device, e.g., to the extruding device and/or the separating device(s), may be controlled and/or adjusted based on an output of food pieces from the sorting station. For example, the feeding rate may be increased, if the output of food pieces from the sorting station with a size outside of the defined criteria increases, which may deem the respective food pieces as requiring a re-feed.

In one embodiment, the apparatus may be configured to control one or several parameters and/or conditions, such as the parameters and/or conditions identified above, to ensure that one defined group of food pieces contains at least 20% of all processed food pieces, optionally at least 30% of all processed food pieces, optionally at least 50% of all processed food pieces. The term “% of all processed food pieces” may refer to a percentage by weight (wt %) of all processed food pieces, a percentage of a total area of all processed food pieces, a percentage by volume (vol %) of all processed food pieces or a percentage of a number of all processed food pieces.

In one embodiment, the control unit may be configured to adjust the process parameters of the separating device based on the measurand provided by the sorting device to provide smaller food pieces.

The apparatus may include at least one control unit and at least one data providing device configured to provide data relating to one or more measurands of one or more components of the apparatus and/or the extrudate and/or the food pieces to the control unit. The control unit may be configured to provide one or more signals for controlling one or more process parameters of one or more components of the apparatus.

The control unit may be configured to provide an open loop control, e.g., feed forward control and/or feed backward control, or a closed loop control.

The present disclosure further relates to a set of food items produced from at least one plant-based proteinaceous extrudate, the food items optionally being produced by the apparatus according to any of the embodiments described herein. The food pieces differ in one or more physical properties of the food pieces.

The configurations, features and advantages, as described above with respect to the apparatus, apply to the set of food items accordingly.

Optionally, the set comprises randomly separated or non-identically shaped and/or non-identically sized food items.

The food items of the set of food items differ in size, shape, and/or color.

The set of food items may be further specified such that a size of the smallest food piece is at most 95%, optionally at most 96%, optionally at most 97%, optionally at most 98%, optionally at most 99%, of a size of the largest food piece.

The present disclosure relates to a method of processing plant-based proteinaceous food items, optionally by means of the apparatus according to any of the embodiments described herein. The method includes the following steps:
(a) providing at least one plant-based proteinaceous extrudate by means of at least one extruding device;
(b) separating the extrudate into a plurality of food pieces by means of at least one separating device; and
(c) sorting the food pieces by means of at least one sorting station based on one or more criteria.

The configurations, features and advantages, as described above with respect to the apparatus, apply to the method accordingly.

The food pieces may be classified into one or more classes of a plurality of classes based at least on the one or more criteria by means of at least one sorting device of the sorting station.

The food pieces may be allocated such that food pieces which are classified into a first class by the sorting device based on the one or more criteria are fed to at least a first processing station and food pieces which are classified into a second class by the sorting device, the second class being different from the first class, are fed to at least a second processing station which is different from the first processing station.

In one embodiment, the processing station is a packing station, wherein food pieces of a first class a packed and labelled with at least one first label and food pieces of a second class are packed at the same or similar packing station with at least one second label, wherein the information provided on the first label and the second label differ from each other.

A size of the largest food piece of the first class may be no more than 20%, optionally no more than 15%, optionally no more than 10%, optionally no more than 1%, larger than a size of the smallest food piece of the second class.

A size of the smallest food piece of one class may be at most 95%, optionally at most 96%, optionally at most 97%, optionally at most 98%, optionally at most 99%, of a size of the largest food piece of the same class.

The one or more criteria applied at the sorting station may relate to one or more physical properties of the food pieces, optionally one or more physical properties which are detectable by at least one detecting device which is optionally provided by the apparatus.

The following list of aspects provides preferred embodiments of the present disclosure:
1. An apparatus for processing food items, optionally plant-based proteinaceous food items, including:
   at least one pre-forming device, optionally an extruding device, configured to provide at least one plant-based proteinaceous pre-form, optionally extrudate;
   at least one separating device configured to separate the pre-form, optionally extrudate, into a plurality of food pieces; and
   at least one sorting station configured for sorting the food pieces based on one or more criteria.
2. The apparatus according to aspect 1, wherein the sorting station includes a sorting device which is configured to classify the food pieces into one or more classes of a plurality of classes based at least on the one or more criteria.
3. The apparatus according to aspect 1 or 2, wherein the sorting station includes a sorting device which is configured to classify the food pieces into one or more classes of a plurality of classes based on the one or more criteria, wherein the sorting device is configured to allocate the food pieces based on the one or more criteria such that food pieces which are classified into a first class by the sorting device are fed to at least a first processing station and food pieces which are classified into a second class by the sorting device, which is different from the first class, are fed to at least a second processing station which is different from the first processing station.
4. The apparatus according to aspect 3, wherein the sorting device is configured such that a size of the largest food piece of the first class is no more than 20%, optionally no more than 15%, optionally no more than 10%, optionally no more than 1%, larger than a size of the smallest food piece of the second class.
5. The apparatus according to aspect 3 or 4, wherein the sorting device is configured such that a size of the smallest food piece of one class is at most 95%, optionally at most 96%, optionally at most 97%, optionally at most 98%, optionally at most 99%, of a size of the largest food piece of the same class.
6. The apparatus according to any of the preceding aspects, wherein the one or more criteria relate to one or more physical properties of the food pieces, optionally one or more physical properties which are detectable by at least one detecting device which is optionally provided by the apparatus.
7. The apparatus according to any of the preceding aspects, wherein the one or more criteria relate to one or more of the following: a projected area of the food pieces, an aspect ratio of the food pieces, a shape of the food pieces, a size of the food pieces, a length of the food pieces, a perimeter of the food pieces, a colour of the food pieces, a protein content of the food pieces, a water content of the food pieces, a density of the food pieces, a contour of the food pieces, a circumference of the food pieces and/or a weight of the food pieces.
8. The apparatus according to any of the preceding aspects, wherein the sorting station is configured to sort the food pieces based on information provided to and/or from one or more neural networks, optionally wherein the one or more criteria are defined and/or altered and/or applied by the one or more neural networks, optionally wherein the one or more criteria are defined and/or altered and/or applied by the one or more neural networks in a manner which resembles a learning human.
9. The apparatus according to any of the preceding aspects, wherein the sorting station includes at least one sorting device configured to at least partially automatically and/or digitally sort the food pieces based on the one or more criteria.
10. The apparatus according to any of the preceding aspects, wherein the sorting station includes at least one sorting device which includes at least one detecting device configured to detect one or more physical properties of the food pieces, optionally at least one of a size, a shape, and a color of the food pieces.
11. The apparatus according to aspect 10, wherein the detecting device includes one or more of the following: an optical detecting device, a tactile detecting device and an ultrasonic detecting device.
12. The apparatus according to any of the preceding aspects, wherein the extrudate is one or more of the following: a high-moisture extrudate comprising at least 35 wt % water, and a fibrous structure.
13. The apparatus according to any of the preceding aspects, further including at least one re-feed device configured to feed one or more of the food pieces to an upstream position relative to the extruding device and/or the separating device to re-feed the food pieces to the extruding device and/or the separating device.
14. The apparatus according to aspect 13, wherein no more than 50%, optionally no more than 40%, optionally no more than 30%, of all processed food pieces are re-fed to the extruding device and/or the separating device.
15. The apparatus according to aspect 13 or 14, wherein the apparatus is configured such that one or more of the food pieces are re-fed to the extruding device and/or the separating device based on the one or more criteria.
16. The apparatus according to any of the preceding aspects, wherein the apparatus is configured to convert at least 80%, optionally at least 85%, optionally at least 90%, optionally at least 95%, optionally at least 96%, optionally at least 97%, optionally at least 98%, optionally at least 99%, of a raw plant-based proteinaceous material at an inlet of the extruding device to edible food pieces.
17. The apparatus according to any of the preceding aspects, wherein the separating device is configured to separate the extrudate into a plurality of food pieces in a manner such that the separated food pieces vary, optionally in at least one or more of the following physical properties: shape, size, weight, volume, texture, density, aspect ratio, a projected area, and one or more dimensions, optionally at least in length.
18. The apparatus according to any of the preceding aspects, further including at least one conditioning device configured to condition the extrudate and/or the food pieces to one or more target states of the extrudate and/or the food pieces.
19. The apparatus according to aspect 18, wherein the conditioning device is configured to condition the extrudate and/or the food pieces by controlling one or more of the following: at least one temperature, at least one colour and at least one structural property of the extrudate and/or the food pieces.
20. The apparatus according to aspect 18 or 19, wherein the conditioning device includes one or more sensors configured to detect one or more physical properties of the extrudate and/or the food pieces, optionally wherein the one or more sensors include one or more of the following: at least one temperature sensor, at least one tactile sensor, at least one ultrasonic sensor and at least one optical sensor.
21. The apparatus according to any of aspects 18 to 20, wherein the conditioning device is configured to provide, optionally in an adjustable manner, a duration until the extrudate and/or the food pieces are processed in a processing step which is downstream of the extruding device and/or the separating device, respectively.
22. The apparatus according to any of the preceding aspects, wherein the sorting device includes at least one grouping unit configured to physically separate and/or group at least a first type of food pieces from at least a second type of food pieces based on the one or more criteria.
23. The apparatus according to aspect 22, wherein the grouping unit includes at least one of the following:
   at least one fluid emitting unit configured to eject a fluid to exert a force on one or more food pieces to physically separate and/or group the food pieces, and
   at least one handling device configured to contact, in a tactile manner, one or more food pieces to physically separate and/or group the food pieces.
24. The apparatus according to any of the preceding aspects, wherein the grouping unit includes at least one sieving device configured to separate smaller food pieces from larger food pieces, optionally wherein the sieving device is a vibrating sieve, optionally a continuously vibrating sieve.
25. The apparatus according to aspect 24, wherein the sieving device is adaptable to food pieces of varying sizes.
26. The apparatus according to any of the preceding aspects, wherein the apparatus is configured to control, optionally automatically control, one or more process parameters of one or more devices provided by the apparatus.
27. The apparatus according to aspect 26, wherein the apparatus is configured to control the one or more process parameters based on one or more measurands related to a device of the apparatus and/or the extrudate and/or the food pieces.
28. The apparatus according to aspect 27, wherein the measurands include one or more physical properties of the food pieces and/or the food items, optionally wherein the one or more physical properties are detectable by at least one detecting device.
29. The apparatus according to aspect 27 or 28, wherein the measurands include one or more physical properties of a raw material of the extrudate fed into the extruding device, optionally wherein the one or more physical properties are detectable by at least one detecting device.
30. The apparatus according to aspect 29, wherein the physical properties include one or more of the following: at least one colour, at least one protein content, at least one water content, at least one solubility, at least one pH value and at least one particle size of one or more particles in the raw material.
31. The apparatus according to any of aspects 27 to 30, wherein the measurands include one or more of the following parameters of the extruding device: at least one temperature imparted to the extrudate, at least one residence time of the extrudate in the extruding device, at least one pressure of the extrudate in the extruding device, at least one torque of the extruding device and at least one specific mechanical energy (SME) of the extruding device.
32. The apparatus according to any of aspects 27 to 31, wherein the measurands include one or more of the following parameters of the extrudate: at least one flow rate of the extrudate exiting the extruding device, at least one colour of the extrudate, at least one temperature of the extrudate, at least one density of the extrudate, at least one pH value of the extrudate, at least one hardness of the extrudate, at least one fibrosity of the extrudate, at least one size of the extrudate, at least one weight of the extrudate, at least one moisture content of the extrudate, at least one stiffness of the extrudate, at least one extensibility of the extrudate in at least one dimension and at least one cross-sectional shape of the extrudate.
33. The apparatus according to any of aspects 26 to 32, wherein the apparatus is configured to control a feeding rate of one or more ingredients of a raw material of the extrudate.
34. The apparatus according to any of aspects 26 to 33, wherein the apparatus is configured to control a throughput of the food pieces.
35. The apparatus according to any of aspects 26 to 34, wherein the apparatus is configured to control a rotational speed of the extruding device.
36. The apparatus according to any of aspects 26 to 35, wherein the apparatus is configured to control a temperature in at least a section of the extruding device.
37. The apparatus according to any of aspects 26 to 36, wherein the apparatus is configured to control a process parameter to control a residence time of the raw material in the extruding device.
38. The apparatus according to any of aspects 26 to 37, wherein the apparatus is configured to control a backpressure of the extruding device.
39. The apparatus according to any of aspects 26 to 38, wherein the apparatus is configured to control a process parameter of the separating device, optionally a separation speed or a feed rate of extrudate into the separating device.
40. The apparatus according to any of aspects 26 to 39, wherein the apparatus is configured to control a process parameter to control a residence time of the food pieces and/or the food items in at least one conditioning device.
41. The apparatus according to any of aspects 26 to 40, wherein the apparatus is configured to control a process parameter to control a temperature of the extrudate prior to entering the separating device.
42. The apparatus according to any of aspects 26 to 41, wherein the apparatus is configured to control a duration until the extrudate and/or the food pieces are processed in a processing step which is downstream of the extruding device and/or the separating device and/or at least one of a plurality of separating devices.
43. The apparatus according to any of aspects 26 to 42, wherein the apparatus is configured to control a conveying speed of the food pieces through at least a section of the apparatus.
44. The apparatus according to any of aspects 26 to 43, wherein the apparatus is configured to control a feeding rate of food pieces into and/or from a re-feed device.
45. The apparatus according to any of aspects 26 to 44, wherein the apparatus is configured to control at least one of the one or more criteria based on which the sorting station is configured to sort the food pieces.
46. The apparatus according to any of the preceding aspects, wherein the apparatus includes at least one control unit and at least one data providing device configured to provide data relating to one or more measurands of a device of the apparatus and/or the extrudate and/or the food pieces to the control unit, wherein the control unit is configured to provide one or more signals for controlling one or more process parameters of one or more devices of the apparatus.
47. A set of food items produced from at least one plant-based proteinaceous extrudate, the food items optionally being produced by the apparatus according to any of the preceding aspects, wherein the food pieces differ in one or more physical properties of the food pieces.
48. The set of food items according to aspect 47, wherein the food pieces differ in size, shape, and/or color.
49. The set of food items according to aspect 47 or 48, wherein a size of the smallest food piece is at most 95%, optionally at most 96%, optionally at most 97%, optionally at most 98%, optionally at most 99%, of a size of the largest food piece.
50. A method of processing plant-based proteinaceous food items, optionally by means of the apparatus according to any of aspects 1 to 46, the method including the following steps:
   providing at least one plant-based proteinaceous extrudate by means of at least one extruding device;
   separating the extrudate into a plurality of food pieces by means of at least one separating device; and
   sorting the food pieces by means of at least one sorting station based on one or more criteria.
51. The method according to aspect 50, wherein the food pieces are classified into one or more classes of a plurality of classes based at least on the one or more criteria by means of at least one sorting device of the sorting station.
52. The method according to aspect 51, wherein the food pieces are allocated such that food pieces which are classified into a first class by the sorting device based on the one or more criteria are fed to at least a first processing station and food pieces which are classified into a second class by the sorting device, the second class being different from the first class, are fed to at least a second processing station which is different from the first processing station.
53. The method according to aspect 51 or 52, wherein a size of the largest food piece of the first class is no more than 20%, optionally no more than 15%, optionally no more than 10%, optionally no more than 1%, larger than a size of the smallest food piece of the second class.
54. The method according to any of aspects 51 to 53, wherein a size of the smallest food piece of one class is at most 95%, optionally at most 96%, optionally at most 97%, optionally at most 98%, optionally at most 99%, of a size of the largest food piece of the same class.
55. The method according to any of aspects 50 to 54, wherein the one or more criteria relate to one or more physical properties of the food pieces, optionally one or more physical properties which are detectable by at least one detecting device which is optionally provided by the apparatus.

The present summary is provided only by way of example and not limitation. Other aspects of the present invention will be appreciated in view of the entirety of the present disclosure, including the entire text, claims, and accompanying figures.

### DESCRIPTION OF FIGURES

The present disclosure is further illustrated by the following examples and figures, from which further embodiments and advantages can be drawn. These examples are meant to illustrate the present invention but not to limit its scope.

FIG. 1 shows a schematic overview of an apparatus 10 for processing plant-based proteinaceous food items 11 according to an embodiment of the present invention. The apparatus 10 comprises an extruding device 16, a separating device 18, a sorting station 20, and optionally a conditioning device 24 and/or a re-feed device 28. The apparatus 10 thus provides an extrudate 32 by means of the extruding device 16, separates said extrudate 32 into a plurality of food pieces 12 by means of the separating device 18 and sorts said food pieces 12 at the sorting station 20 to obtain one or more food items 11 and/or optionally re-feed certain food pieces 12 into the apparatus 10.

FIG. 2 shows an example of food pieces 12, wherein (A) shows food pieces 12 downstream from the separating device 18 with a broad size distribution and thus insufficient quality to be packaged in one food packaging and (B) shows food pieces 12 which have passed the sorting station 20 to sort said food pieces 12 based on one or more criteria, resulting in a more narrow size distribution.

FIG. 3 shows an example of food pieces 12 classified in the sorting station 20 as “good” (A), “too large” (B), and “too small” (C) according to one or more length and width criteria, as described in Example 2.

FIG. 4 shows examples of physical properties applied to sort the food pieces 12 at the sorting station, depicting (A) a perimeter, (B) a length, and (C) a length and a width combined as an aspect ratio as length/width, as described in Example 3.

FIG. 5 shows a detection of food pieces 12 with a darker colour among many food pieces 12 in the sorting station 20, as described in Example 4.

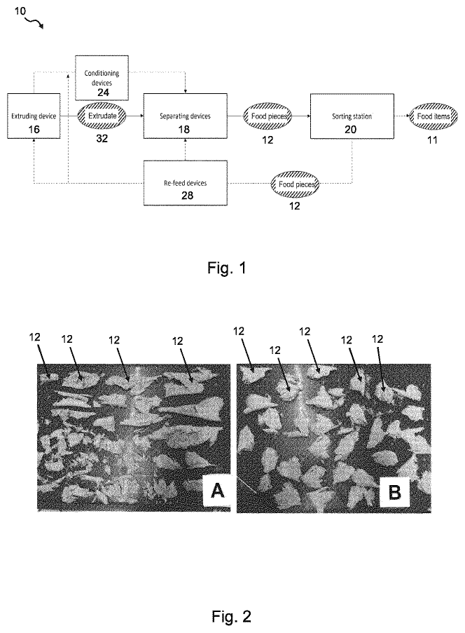

### EXAMPLES

### Example 1

According to Example 1, a continuous ribbon of extrudate 32 with a width of approximatively 6 cm was provided by the extruding device 16 configured to perform high-moisture extrusion. The extrudate 32 was composed of pea protein, soy protein and water. The continuous ribbon was optionally cut into long discrete ribbons and then fed into the separating device 18. The separating device 18 was configured to rip the ribbon into pieces along the fibrous structure provided by the extrusion process. When not properly adjusting the parameters of the separating device 18 to the extrudate characteristics and when not applying any sorting step, the separating step resulted in food pieces 12 with a very broad size distribution and several food pieces 12 which were either too large or too small, as shown in FIG. 2 (A).

By applying one or more sorting steps at the sorting station 20, a more narrow size distribution of the food pieces 12 may be achieved, as shown in FIG. 2 (B). For instance, one or more food pieces 12 which do not meet one or more predetermined criteria, e.g., a size or range of sizes, may be sorted out and/or re-fed to the re-feed devices 28. For instance, if the respective food pieces 12 are determined, at the sorting station 20, as being “too large”, the respective food pieces 12 may be re-fed to the separating device 18 to separate the respective food pieces 12 into smaller pieces. If the respective food pieces 12 are determined, at the sorting station 20, as being “too small”, the respective food pieces 12 may be re-fed to the extruding device 16 for re-extrusion. Moreover, parameters of the separating device 18 may also be adjusted. This may result in non-identical food pieces 12 with a narrower size distribution sufficient to be packaged in one food packaging. Moreover, the food pieces 12 have arbitrary or natural-looking shapes and non-identical sizes

### Example 2

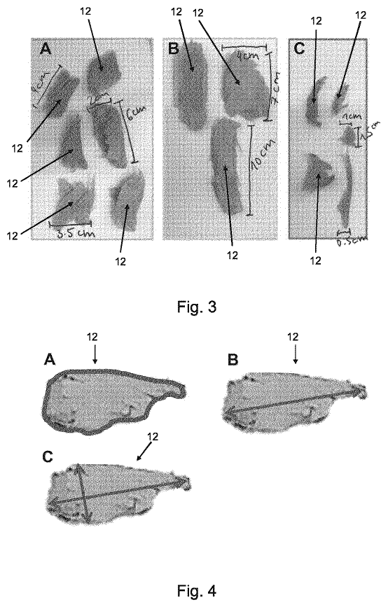

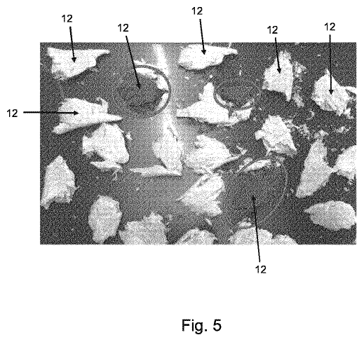

In Example 2, a continuous carpet of extrudate 32 based on pea protein with a width of 37 cm was provided by the extruding device 16 configured to perform high-moisture extrusion and was cut into large discrete ribbons, which were fed into two separating devices 18 arranged in series, followed by the sorting station 20. In the sorting station 20, the food pieces 12 were classified/graded as “good”, “too large” and “too small” according to the lengths and widths of the respective food pieces 12 by applying the following criteria (height=dimension given by the height of the cooling die of the extruding device 16, length=longer dimension, width=shorter dimension, all measured at broadest position):
“Good”: Length and width at least 2 cm, width not larger than 4 cm, length not larger than 6 cm, see FIG. 3 (A)
“Too large”: Width larger than 4 cm and length larger than 6 cm, see FIG. 3 (B)
“Too small”: Width or length smaller than 2 cm, see FIG. 3 (C)

The food pieces 12 which were classified/graded as being “good” were packaged as main food items 11. The food pieces 12 which were classified/graded as being “too large” were either packaged for a side product requiring larger pieces, referred to as second food items, or re-fed into the separating device 18. The food pieces 12 which were classified/graded as being “too small” were either further processed for a side product requiring smaller pieces, referred to as third food item, or ground into smaller pieces of more regular size and shape and re-fed into the extruding device 16.

### Example 3

The food pieces 12 in Example 3 were derived from pea protein-based extrudate 32 and were sorted in an optical sorting device included in the sorting station 20, wherein images were taken of each food piece 12 running through the apparatus 10 on a conveyor belt. On the images, each food piece was detected and analyzed by image processing based on its perimeter, as shown in FIG. 4 (A), longest dimension (length), as shown in FIG. 4 (B), and aspect ratio, i.e., the ratio of the longest dimension in length to the shortest dimension in width, as shown in FIG. 4 (C). Specific criteria were defined such that food pieces with a perimeter of <9 cm and an aspect ratio <1.2 were sorted out into a class of pieces which were determined to be “too small”. Pieces with a perimeter of >15 cm or a width of above 4.5 cm and an aspect ratio of <1.2 were sorted out into a class of pieces which were determined to be “too large”. All other food pieces 12 were considered to be “good” or “sufficient” for the produced food items 11.

### Example 4

The food pieces 12 in Example 4 were made by feeding pea protein, pea fibers and water into an extruder heating to above 110° C. under shear and extruder through a cooling die to form a ribbon or carpet of a proteinaceous extrudate 32 with a fibrous structure and subsequently feeding this material to the separating device 18. As the extruding device 16 and powder feeders configured to feed the pea protein-containing powder into the extruding device 10 was prone to unstable feeding, the extrudate composition was inaccurate with areas of too high powder content and too low water content. As food pieces 12 containing such too dry extrudate 32 are very hard and unpleasant to eat, the apparatus 10 was configured to sort out such food pieces by means of colour detection. At the sorter, the colour was detected through optical measures by determining the RGB value. The pieces with a RGB value beyond the desired colour were sorted out by a pressurized air stream and collected in a re-feed stream to the extruding device 16.

### Example 5

Food pieces 12 were made as described in Example 4. A sorting device included in the sorting station 20 was configured to sort the food pieces 12 according to one or more size criteria in Example 5. This resulted in an output of food pieces 12, which were classified as being “good”, of only 20 wt % of the provided extrudate 32, 20 wt % of the provided extrudate 32 resulted in food pieces 12 which were classified as being “too small” and 60 wt % of the provided extrudate 32 resulted in food pieces 12 which were classified as being “too large”. This information was provided to a control unit, which in turn decreased a conveyor belt speed of at least one conveyor belt feeding the extrudate 32 into a cutting unit of the separating device 18 resulting in a reduction in size of the food pieces 12.

Although the present invention has been described with reference to preferred embodiments, workers skilled in the art will recognize that changes may be made in form and detail without departing from the spirit and scope of the invention.

1-16. (canceled)

17. An apparatus for processing plant-based proteinaceous food items, including:
at least one extruding device configured to provide at least one plant-based proteinaceous extrudate;
at least one separating device configured to separate the extrudate into a plurality of food pieces; and
at least one sorting station configured for sorting the food pieces based on one or more criteria.

18. The apparatus according to claim 17, wherein the sorting station includes at least one sorting device which is configured to classify the food pieces into one or more classes of a plurality of classes based at least on the one or more criteria.

19. The apparatus according to claim 17, wherein the sorting station includes at least one sorting device which is configured to classify the food pieces into one or more classes of a plurality of classes based on the one or more criteria, wherein the sorting device is configured to allocate the food pieces based on the one or more criteria such that food pieces which are classified into a first class by the sorting device are fed to at least a first processing station and food pieces which are classified into a second class by the sorting device, which is different from the first class, are fed to at least a second processing station which is different from the first processing station.

20. The apparatus according to claim 19, wherein the sorting device is configured such that a size of the largest food piece of the first class is no more than 20% or no more than 15% or no more than 10% or no more than 1% larger than a size of the smallest food piece of the second class.

21. The apparatus according to claim 17, wherein the one or more criteria relate to one or more physical properties of the food pieces.

22. The apparatus according to claim 21, wherein the one or more physical properties of the food pieces are detectable by at least one detecting device.

23. The apparatus according to claim 21, wherein the one or more criteria relate to at least one of the following: a projected area of the food pieces, an aspect ratio of the food pieces, a shape of the food pieces, a size of the food pieces, a length of the food pieces, a perimeter of the food pieces, a colour of the food pieces, a protein content of the food pieces, a water content of the food pieces, a density of the food pieces, a contour of the food pieces, a circumference of the food pieces, and a weight of the food pieces.

24. The apparatus according to claim 17, wherein the extrudate is one or more of the following: a high-moisture extrudate comprising at least 35 wt % water, and a fibrous structure.

25. The apparatus according to claim 17, further including at least one re-feed device configured to feed one or more of the food pieces to an upstream position relative to at least one of the extruding device and the separating device to re-feed the food pieces to at least one of the extruding device and the separating device.

26. The apparatus according to claim 25, wherein the apparatus is configured such that one or more of the food pieces are re-fed to at least one of the extruding device and the separating device based on the one or more criteria.

27. The apparatus according to claim 17, wherein the separating device is configured to separate the extrudate into a plurality of food pieces in a manner such that the separated food pieces vary in at least one or more of the following physical properties: shape, size, weight, volume, texture, density, aspect ratio, a projected area, and one or more dimensions.

28. The apparatus according to claim 17, further including at least one conditioning device configured to condition at least one of the extrudate and the food pieces to one or more target states of at least one of the extrudate and the food pieces.

29. The apparatus according to claim 28, wherein the conditioning device is configured to condition at least one of the extrudate and the food pieces by controlling one or more of the following: at least one temperature, at least one colour and at least one structural property of at least one of the extrudate and the food pieces.

30. The apparatus according to claim 28, wherein the conditioning device is configured to provide a duration until at least one of the extrudate and the food pieces are processed in a processing step which is downstream of at least one of the extruding device and the separating device, respectively.

31. The apparatus according to claim 17, wherein at least one of the sorting device and the sorting station include(s) at least one grouping unit configured to at least one of physically separate and group at least a first type of food pieces from at least a second type of food pieces based on the one or more criteria, wherein the grouping unit includes at least one of the following:
at least one fluid emitting unit configured to eject a fluid to exert a force on one or more food pieces to at least one of physically separate and group the food pieces, and at least one handling device configured to contact, in a tactile manner, one or more food pieces to at least one of physically separate and group the food pieces.

32. The apparatus according to claim 17, wherein the apparatus is configured to control the one or more process parameters based on one or more measurands related to a device of at least one of the apparatus, the extrudate, and the food pieces.

33. The apparatus according to claim 32, wherein the measurands include at least one of:
one or more physical properties of at least one of the food pieces and the food items, wherein the one or more physical properties are detectable by at least one detecting device, wherein the measurands include one or more physical properties of a raw material of the extrudate fed into the extruding device, wherein the one or more physical properties are detectable by at least one detecting device, wherein the physical properties include one or more of the following: at least one colour, at least one protein content, at least one water content, at least one solubility, at least one pH value and at least one particle size of one or more particles in the raw material;
and
one or more physical properties of a raw material of the extrudate fed into the extruding device, wherein the one or more physical properties are detectable by at least one detecting device, wherein the physical properties include one or more of the following: at least one colour, at least one protein content, at least one water content, at least one solubility, at least one pH value and at least one particle size of one or more particles in the raw material;
and
one or more of the following parameters of the extruding device: at least one temperature imparted to the raw material of the extrudate, at least one residence time of the raw material of the extrudate in the extruding device, at least one pressure of the extrudate in the extruding device, at least one torque of the extruding device and at least one specific mechanical energy (SME) of the extruding device;
and
one or more of the following parameters of the extrudate: at least one flow rate of the extrudate exiting the extruding device, at least one colour of the extrudate, at least one temperature of the extrudate, at least one density of the extrudate, at least one pH value of the extrudate, at least one hardness of the extrudate, at least one fibrosity of the extrudate, at least one size of the extrudate, at least one weight of the extrudate, at least one moisture content of the extrudate, at least one stiffness of the extrudate, at least one extensibility of the extrudate in at least one dimension and at least one cross-sectional shape of the extrudate.

34. The apparatus according to claim 32, wherein the apparatus is configured to control one or more of the following:
a feeding rate of one or more ingredients of a raw material of the extrudate,
a throughput of the food pieces,
a rotational speed of the extruding device,
a temperature in at least a section of the extruding device,
a process parameter to control a residence time of the raw material in the extruding device,
a backpressure of the extruding device,
a process parameter of the separating device, a separation speed or a feed rate of extrudate into the separating device,
a process parameter to control a residence time of at least one of the food pieces and the food items in at least one conditioning device,
a process parameter to control a temperature of the extrudate prior to entering the separating device,
a duration until at least one of the extrudate and the food pieces are processed in a processing step which is downstream of at least one of the extruding device, the separating device, and at least one of a plurality of separating devices,
a conveying speed of the food pieces through at least a section of the apparatus,
a feeding rate of food pieces into or from a re-feed device, and
at least one of the one or more criteria based on which the sorting station is configured to sort the food pieces.

35. A set of food items produced from at least one plant-based proteinaceous extrudate, the food items being produced by the apparatus according to claim 17, wherein the food items differ in one or more physical properties of the food items.

36. A method of processing plant-based proteinaceous food items by means of the apparatus according to claim 17, the method including the following steps:
providing at least one plant-based proteinaceous extrudate by means of at least one extruding device;
separating the extrudate into a plurality of food pieces by means of at least one separating device; and
sorting the food pieces at at least one sorting station based on one or more criteria.
